(19) United States
(12) Patent Application Publication
(10) Pub. No.: US 2021/0133657 A1
(43) Pub. Date: May 6, 2021

(54) TASK ADJUSTMENT METHOD, DEVICE, EQUIPMENT AND NON-VOLATILE STORAGE MEDIUM

(71) Applicant: Chongqing University, Chongqing (CN)

(72) Inventors: Baizhan LI, Chongqing (CN); Baiyi LI, Chongqing (CN)

(21) Appl. No.: 17/090,888

(22) Filed: Nov. 6, 2020

(30) Foreign Application Priority Data
Nov. 6, 2019 (CN) 201911078710.5

(51) Int. Cl. G06Q 10/06; G06F 9/48; G06F 16/28; G06Q 10/10; G06Q 50/08

(52) U.S. Cl. CPC G06Q 10/06316; G06F 9/4881; G06Q 50/08; G06Q 10/103; G06F 16/288

(57) ABSTRACT

Disclosed are a task adjustment method, a device, an equipment and a non-volatile storage medium. The method includes: acquiring sequence IDs and associated conditions of target tasks, and establishing a task association table according to the sequence IDs and the associated conditions of the target tasks; generating an initial task matrix according to the sequence IDs of the target tasks and the task association table; in a determination that the initial task matrix comprises a task to be processed, adjusting the initial task matrix through a preset rule according to a sequence ID corresponding to the task to be processed to generate a target task matrix; obtaining a task sequence according to the target task matrix; and in a determination that the task sequence satisfies the task association table, generating an execution plan scheme according to the task sequence.

### CROSS REFERENCE TO RELATED APPLICATIONS

This disclosure claims the priority of Chinese Patent Application filed in the National Intellectual Property Administration of China on Nov. 6, 2019, with the application number 201911078710.5 and Title “Task Adjustment Method, Device, Equipment And Storage Medium”, the entire contents of which are hereby incorporated by reference.

### TECHNICAL FIELD

This disclosure relates to the technical field of task planning, in particular to a task adjustment method, a device, an equipment and a non-volatile storage medium.

### BACKGROUND

In related technologies, engineering project planning mainly relies on the personal experience of the planning engineer to determine the logical relationship among work tasks. Because personal experience and knowledge are limited, many work tasks and logical relationships are simplified. In addition, the “guess and estimate” approach is frequently used in the planning process to solve problem, leading to “separation of planning and execution”. The dependencies among many tasks are ignored in the planning stage, which is not exposed until the execution stage, leading to waste of time and cost of construction projects.

The above content is only used to assist in understanding the technical solution of this disclosure, and does not mean that the above content is prior art.

### SUMMARY

The main object of this disclosure is to provide a task adjustment method, a device, an equipment and a storage medium, aiming to reduce the time waste and cost of construction projects.

In order to achieve the above object, this disclosure provides a task adjustment method, which includes:

acquiring sequence IDs and associated conditions of target tasks, and establishing a task association table according to the sequence IDs and the associated conditions of the target tasks;

generating an initial task matrix according to the sequence IDs of the target tasks and the task association table;

in a determination that the initial task matrix includes a task to be processed, adjusting the initial task matrix through a preset rule according to a sequence ID corresponding to the task to be processed to generate a target task matrix;

obtaining a task sequence according to the target task matrix; and

in a determination that the task sequence satisfies the task association table, generating an execution plan scheme according to the task sequence.

In an embodiment, acquiring sequence IDs and associated conditions of target tasks, and establishing a task association table according to the sequence IDs and the associated conditions of the target tasks includes:

acquiring the sequence IDs of the target tasks, and traversing the sequence IDs of the target tasks;

taking a current target task corresponding to a traversed sequence ID as a current task to be associated;

acquiring an associated condition corresponding to the current task to be associated;

matching the associated condition corresponding to the current task to be associated with the target tasks;

associatively marking a sequence ID corresponding to the current task to be associated and a sequence ID of a matched target task to generate an associated ID; and

establishing the task association table according to the associated ID.

In an embodiment, generating an initial task matrix according to the sequence IDs of the target tasks and the task association table includes:

counting a number of the target tasks according to the sequence IDs of the target tasks;

establishing an initial matrix with N rows and N columns according to the number of the target tasks, where N is the number of the target tasks; and

inputting the sequence IDs of the target tasks and the task association table into the initial matrix with N rows and N columns to obtain the initial task matrix.

In an embodiment, the task to be processed is an empty row subtask or an empty column subtask; and

where in a determination that the initial task matrix comprises a task to be processed, adjusting the initial task matrix through a preset rule according to a sequence ID corresponding to the task to be processed to generate a target task matrix includes:

in a determination that the initial task matrix includes the empty row subtask or the empty column subtask, adjusting the initial task matrix through the preset rule according to the sequence ID corresponding to the task to be processed to generate the target task matrix.

In an embodiment, in a determination that the initial task matrix includes the task to be processed, adjusting the initial task matrix through a preset rule according to a sequence ID corresponding to the task to be processed to generate a target task matrix includes:

in a determination that the initial task matrix includes the empty row subtask or the empty column subtask, marking and moving the empty row subtask or the empty column subtask in the initial task matrix;

according to an initial task matrix after moving the empty row subtask or the empty column subtask and the task association table, generating a matrix of task to be processed through a strong connected relationship aggregation method;

in a determination that the matrix of task to be processed is not a lower triangular matrix, generating a lower triangular matrix through a conversion method according to the matrix of task to be processed; and

taking the lower triangular matrix as the target task matrix.

In an embodiment, obtaining a task sequence according to the target task matrix includes:

extracting the sequence IDs corresponding to the target tasks and the sequence ID corresponding to the task to be processed according to the target task matrix; and

arranging the sequence IDs corresponding to the target tasks and the sequence ID corresponding to the task to be processed to obtain the task sequence.

In an embodiment, after obtaining a task sequence according to the target task matrix, the method further includes:

in a determination that the task sequence does not satisfy the task association table, generating an initial task matrix according to the sequence IDs of the target tasks and the task association table.

In addition, in order to achieve the above object, this disclosure further provides a task adjustment device, which includes:

an acquisition module configured for acquiring sequence IDs and associated conditions of target tasks, and establishing a task association table according to the sequence IDs and the associated conditions of the target tasks;

a generation module configured for generating an initial task matrix according to the sequence IDs of the target tasks and the task association table;

a determination module configured for determining whether the initial task matrix includes a task to be processed;

a rule module configured for in a determination that the initial task matrix includes the task to be processed, adjusting the initial task matrix through a preset rule according to a sequence ID corresponding to the task to be processed to generate a target task matrix;

a sequence module configured for obtaining a task sequence according to the target task matrix; and

a planning module configured for in a determination that the task sequence satisfies the task association table, generating an execution plan scheme according to the task sequence.

In addition, in order to achieve the above object, this disclosure further provides an electronic equipment including a memory, a processor, and a task adjustment program stored on the memory and executable on the processor, and the task adjustment program is configured to implement the operations of the task processing method as described above.

In addition, in order to achieve the above object, this disclosure further provides a non-volatile storage medium with a task adjustment program stored thereon, and the task adjustment program, when executed by the processor, implements the operations of the task adjustment method as described above.

According to this disclosure, acquiring sequence IDs and associated conditions of target tasks, and establishing a task association table according to the sequence IDs and the associated conditions of the target tasks; generating an initial task matrix according to the sequence IDs of the target tasks and the task association table; in a determination that the initial task matrix includes a task to be processed, marking the sequence ID corresponding to the task to be processed in the initial task matrix, and adjusting the initial task matrix to generate a target task matrix; obtaining a task sequence according to the target task matrix; and in a determination that the task sequence satisfies the task association table, generating an execution plan scheme according to the task sequence. In this way, it is realized that the project tasks may be quickly and efficiently prioritized according to logical relationship among the tasks, thereby reducing the time waste and cost of the construction projects, and improving the efficiency of processing tasks.

### BRIEF DESCRIPTION OF THE DRAWINGS

FIG. 1 is a schematic structural diagram of an electronic equipment in a hardware operating environment involved in an embodiment of this disclosure.

FIG. 2 is a schematic flowchart of a task adjustment method according to a first embodiment of this disclosure.

FIG. 3 is a schematic diagram of an initial task matrix.

FIG. 4 is a schematic diagram of a lower triangular matrix.

FIG. 5 is a schematic flowchart of the task adjustment method according to a second embodiment of this disclosure.

FIG. 6 is a structural block diagram of a task adjustment device according to a first embodiment of this disclosure.

The realization of the objects, functional characteristics and advantages of this disclosure will be further described in conjunction with the embodiments and with reference to the drawings.

### DETAILED DESCRIPTION OF THE EMBODIMENTS

It should be understood that the specific embodiments described herein are only used to explain this disclosure, and are not intended to limit this disclosure.

Referring to FIG. 1, FIG. 1 is a schematic structural diagram of an electronic equipment in a hardware operating environment involved in an embodiment of this disclosure.

As shown in FIG. 1, the electronic equipment may include: a processor 1001, such as a Central Processing Unit (CPU), a communication bus 1002, a user interface 1003, a network interface 1004, and a memory 1005. The communication bus 1002 is configured to implement connection communication among these components. The user interface 1003 may include a display and an input unit such as a keyboard, and optionally the user interface 1003 may further include a standard wired interface and a wireless interface. The network interface 1004 may optionally include a standard wired interface and a standard wireless interface (such as a WI-FI interface). The memory 1005 may be a high-speed Random Access Memory (RAM) or a stable non-volatile memory (NVM), such as a disk memory. The memory 1005 may optionally be a storage medium independent of the foregoing processor 1001.

Those skilled in the art may understand that the structure shown in FIG. 1 does not constitute a limitation on the electronic equipment, and more or less components than those illustrated may be included, or certain components may be combined, or different components may be arranged.

As shown in FIG. 1, the memory 1005 as a computer storage medium may include an operating system, a network communication module, a user interface module, and a task adjustment program.

In the electronic equipment shown in FIG. 1, the network interface 1004 is mainly configured for data communication with a network server, and the user interface 1003 is mainly configured for data interaction with users. The processor 1001 and the memory 1005 in the electronic equipment of this disclosure may be set in a task adjustment device. The electronic equipment calls the task adjustment program stored on the memory 1005 through the processor 1001, and executes the task adjustment method provided in the embodiments of this disclosure.

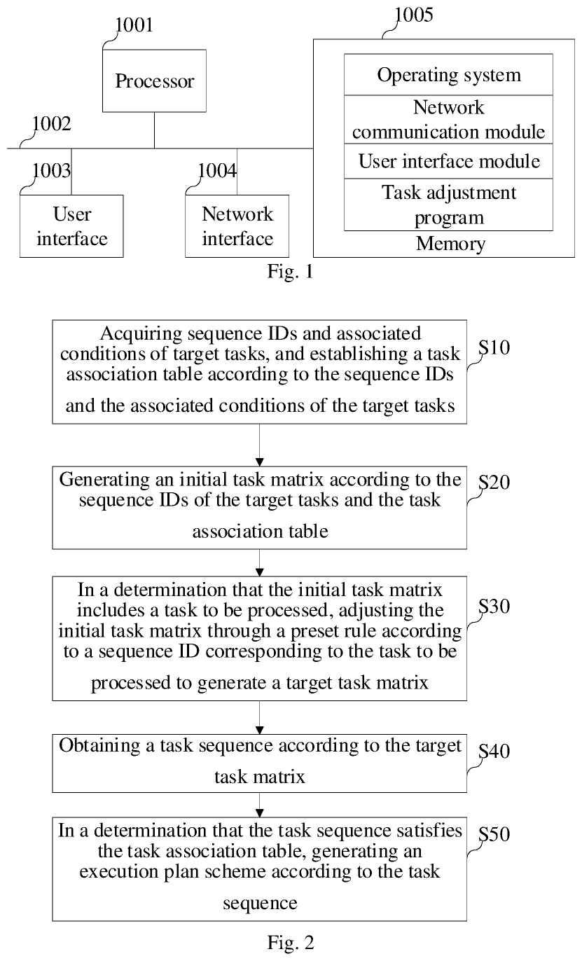

An embodiment of this disclosure provides a task adjustment method. Referring to FIG. 2, FIG. 2 is a schematic flowchart of a task adjustment method according to a first embodiment of this disclosure.

In this embodiment, the task adjustment method includes the operations as follows.

S10, acquiring sequence IDs and associated conditions of target tasks, and establishing a task association table according to the sequence IDs and the associated conditions of the target tasks.

It should be noted that each task is marked with a sequence, so that each task has its own sequence ID. Then an associated condition corresponding to each task is acquired, and a task association table is established according to the sequence IDs and the associated conditions of the target tasks to facilitate finding logical relationship among tasks.

It should be understood that when establishing the task association table, it is necessary to first acquire the sequence IDs of the target tasks, and traverse the sequence IDs of the target tasks, then take a current target task corresponding to a traversed sequence ID as a current task to be associated. Then an associated condition corresponding to the current task to be associated is acquired to be matched with the target tasks, then a sequence ID corresponding to the current task to be associated and a sequence ID of a matched target task are associatively marked to generate an associated ID, and then a task association table is established according to the associated ID.

In addition, it should be noted that, in order to facilitate understanding, an example is provided as follows.

First, extract events based on an example, such as an installation plan of a roof steel structure and a roof curtain wall of a certain 150-meter tower, which has complicated logical relationships. In this case, due to the extremely narrow roof site of the 150-meter tower, the installation plan of the steel structure and the curtain wall of the roof was coordinated many times. After the roof curtain wall design is completed, the building's internal shading system may be designed and installed. In addition, the ice shovel truck needs to be in place under the tower before the steel may be transported to the top of the tower for construction; and the location of the ice shovel truck and the hoisting site condition survey on the work site affect each other. At present, the gate of the construction site is damaged and the ice shovel cannot enter the construction site.

It can be seen from the above example that there are a total of 6 target tasks, and each target task is marked with a sequence ID, which are a, b, c, d, e, f. Assuming that a is determination of curtain wall installation plan, b is that the construction site gate is damaged, and the ice shovel truck may enter after repair of the construction site gate, c is site condition survey of work site, d is determination of installation plan of internal shading system, e is the ice shovel truck in place, and f is determination of steel structure installation plan. Taking a as the current task to be associated, and then traverse the query from a to f. According to the task association condition of a, it may be known that both a and d or a and f may establish a task association connection, then a and d and a and f are marked. Then taking b as the current task to be associated, and then traverse the query from a to f. According to the task association condition of b, it may be known that b and c may establish a task association connection, then b and c are marked. Following this approach, subsequent tasks are traversed and task association connections are established. Finally, c and e may establish a task association connection, d has no task association connection so that d is a task to be processed, e and c and e and f may establish a task association connection, and f and a may establish a task association connection. Then the task association table may be established based on the above task associations.

S20, generating an initial task matrix according to the sequence IDs of the target tasks and the task association table.

It should be noted that a number of target tasks is counted according to the sequence IDs of the tasks. An initial matrix of N rows and N columns is established according to the number of target tasks, and then an initial task matrix is generated according to the sequence IDs of the target tasks and the task association table.

In addition, it should be understood that, in order to facilitate understanding, an example is provided as follows.

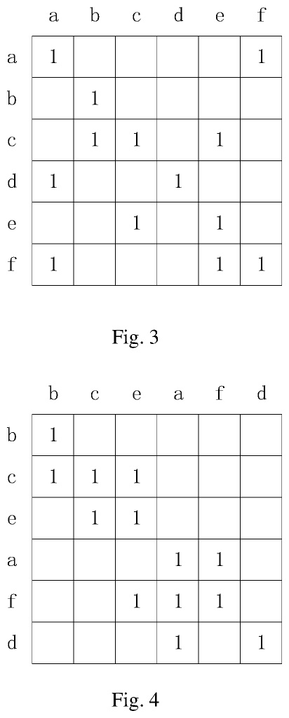

It can be seen from S10 that the target tasks are marked with sequence IDs, which are a, b, c, d, e, f, and the task association relationships are a and d; a and f; b and c; c and e; d; e and c; e and f; and f and a. So an initial matrix of 6 rows and 6 columns needs to be established, and each row and each column are in a sequence of a, b, c, d, e, f. Then the task association relationships of the sequence IDs are inputted into the initial matrix by marking with “1” to obtain the initial task matrix. “task c depends on task b” is marked with “1” in row 3, column 2; “task f depends on task e” is marked with “1” in row 6, column 5; “task d depends on task a” is marked with “1” in row 4, column 1; “task c and task e are interdependent” is marked with “1” in row 3, column 5 and row 5, column 3; “task a and task f are interdependent” is marked with “1” in row 1, column 6 and row 6, column 1; a diagonal line from the upper left to the lower right is the relationship between the task and the task itself, and the “1” mark is also used. By observing the position of “1” in the initial matrix, the association among all tasks may be deduced backwards, and the initial task matrix may be obtained as shown in FIG. 3.

It should be understood that the above is only an example, and does not constitute any limitation to the technical solution of this disclosure. In practical disclosures, those skilled in the art may make settings as needed, and there is no limitation here.

S30, in a determination that the initial task matrix includes a task to be processed, adjusting the initial task matrix through a preset rule according to a sequence ID corresponding to the task to be processed to generate a target task matrix.

It should be noted that the task to be processed is an empty row subtask or an empty column subtask, and it is determined whether there is an empty row subtask or an empty column subtask in the initial task matrix.

It should be understood that if there is an empty row subtask or an empty column subtask in the initial task matrix, the empty row subtask or empty column subtask is marked and moved in the initial task matrix. According to the initial task matrix after moving the empty row subtask or the empty column subtask and the task association table, a strong connected determination matrix is obtained, and tasks with strong connected relationships are searched according to the strong connected determination matrix. Then the tasks with strong connected relationships are aggregated to obtain a matrix of task to be processed. Finally, it is determined whether the matrix of task to be processed is a lower triangular matrix. In a determination that the matrix of task to be processed is not the lower triangular matrix, then finally transform the strong connected determination matrix according to the conversion method to obtain a lower triangular matrix, and the lower triangular matrix is taken as the target task matrix.

In addition, in order to facilitate understanding, an example is provided as follows.

According to the task association relationship, the initial task matrix is marked with “1”. “task c depends on task b” is marked with “1” in row 3, column 2; “task f depends on task e” is marked with “1” in row 6, column 5; “task d depends on task a” is marked with “1” in row 4, column 1; “task c and task e are interdependent” is marked with “1” in row 3, column 5 and row 5, column 3; “task a and task f are interdependent” is marked with “1” in row 1, column 6 and row 6, column 1; a diagonal line from the upper left to the lower right is the relationship between the task and the task itself, and the “1” mark is also used. As shown in FIG. 3.

When the other elements of a certain row in the matrix are all 0 except for the diagonal elements, the task corresponding to this row does not require any information input and needs to be adjusted to the forefront. When the other elements of a certain column in the matrix are all 0 except for the diagonal elements, the task corresponding to this column does not output any information and needs to be adjusted to the end. As shown in FIG. 3, b is an empty row subtask, and d is an empty column subtask. Since the execution of c depends on b, the execution of b does not depend on c, and the execution of task b does not require any information input, therefore, it is necessary to move b to the front row, that is, the empty row subtask is arranged in the front row. The execution of d depends on a, but task d does not output any information. Therefore, it is necessary to move d to the last row, that is, the empty column subtask is arrange in the last row. Then the task execution sequence becomes b, a, c, e, f, d, and the initial task matrix after moving the empty row subtask or the empty column subtask is obtained. a, f, c, e are aggregated according to the strong connected relationship aggregation method, and then the strong connected determination matrix is obtained according to the above adjustment. According to the above description, let the initial task matrix after moving the empty row and empty column subtasks be P, and the strong connected determination matrix be Q, then:

$$P = \begin{matrix}b \\ a \\ c \\ e \\ f \\ d\end{matrix} [ \begin{matrix}1 & 0 & 0 & 0 & 0 & 0 \\ 0 & 1 & 0 & 0 & 1 & 0 \\ 1 & 0 & 1 & 1 & 0 & 0 \\ 0 & 0 & 1 & 1 & 0 & 0 \\ 0 & 1 & 0 & 1 & 1 & 0 \\ 0 & 1 & 0 & 0 & 0 & 1\end{matrix} ] , \\ Q = P ⊗ {P}^{T} = {( {p}_{ij} )}_{n \times n} = \begin{matrix}b \\ a \\ c \\ e \\ f \\ d\end{matrix} [ \begin{matrix}1 & 0 & 0 & 0 & 0 & 0 \\ 0 & 1 & 0 & 0 & 1 & 0 \\ 0 & 0 & 1 & 1 & 0 & 0 \\ 0 & 0 & 1 & 1 & 0 & 0 \\ 0 & 1 & 0 & 0 & 1 & 0 \\ 0 & 0 & 0 & 0 & 0 & 1\end{matrix} ]$$

From the matrix Q, it may be seen that the tasks with strong connected relationship are: in the strong connected matrix, it may be seen that the second row, fifth column and the fifth row, second column in the matrix are both marked with 1, that is, P25*P52=1, which is corresponded to task a and task f (Paf*Pfa=1 and (a is not equal to f)); and the third row, fourth column and fourth row, third column are both marked with 1, that is, P34*P43=1, which is corresponded to task c and task e (Pce*Pec=1 and (c is not equal to e)). Therefore, there is a strong connected relationship between task a and task f, task c and task e. Then tasks a, f, tasks c, e are aggregated to obtain a matrix of task to be processed. At this time, the task execution sequence is adjusted to b, a, f, c, e, d, and then it is determined whether the current matrix is a lower triangular matrix, if not, the matrix of task to be processed is adjusted to obtain a lower triangular matrix, which is shown in FIG. 4.

S40, obtaining a task sequence according to the target task matrix.

S50, in a determination that the task sequence satisfies the task association table, generating an execution plan scheme according to the task sequence.

It should be noted that, according to the target task matrix, the sequence ID corresponding to each task is extracted from top to bottom and from front to back according to each row and column in the matrix. According to the above example, it may be seen that the task sequence obtained by the adjusted lower triangular matrix is b, c, e, a, f, d.

In addition, it should be noted that the sequence is verified according to the task association table, and if the connection is correct, an optimal task execution plan is generated according to the task sequence. If the task sequence does not satisfy the task association table, the initial matrix needs to be re-established until the optimal execution plan for task association is obtained.

In this embodiment, acquiring sequence IDs and associated conditions of target tasks, and establishing a task association table according to the sequence IDs and the associated tasks of the target tasks; generating an initial task matrix according to the sequence IDs of the target tasks and the task association table; in a determination that the initial matrix includes an empty row subtask or an empty column subtask, taking the empty row subtask or empty column subtask as the task to be processed, marking, moving and adjusting the empty row subtask or empty column subtask, and then generating a matrix of task to be processed; in a determination that the matrix of task to be processed is not a lower triangular matrix, adjusting the matrix of task to be processed to generate a target task matrix; obtaining a task sequence according to the target task matrix; and in a determination that the task sequence satisfies the task association table, generating the task sequence into an execution plan scheme. In this way, the optimal task sorting scheme may be obtained quickly and efficiently according to the association relationship among tasks, thereby improving the efficiency of user processing tasks and reducing the time waste and cost of construction projects.

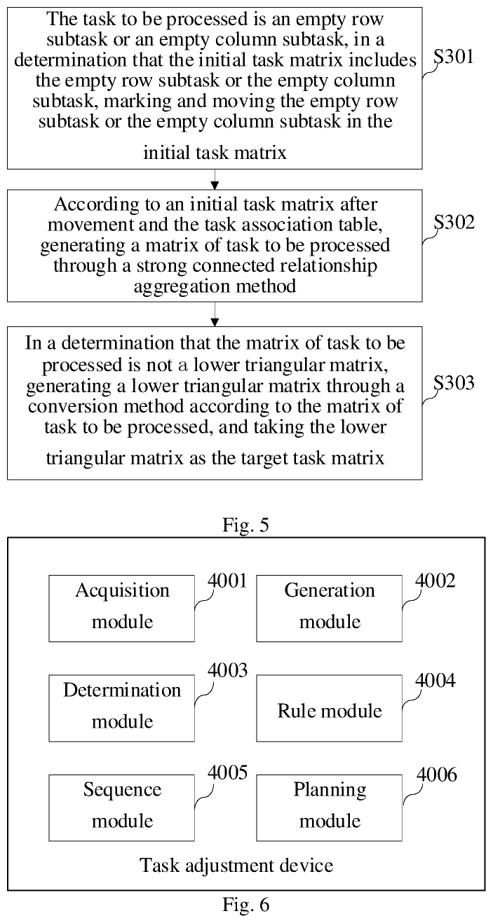

Referring to FIG. 5, FIG. 5 is a schematic flowchart of the task adjustment method according to a second embodiment of this disclosure.

Based on the above first embodiment, S30 is refined into three sub-operations as follows.

S301, the task to be processed is an empty row subtask or an empty column subtask, in a determination that the initial task matrix includes the empty row subtask or the empty column subtask, marking and moving the empty row subtask or the empty column subtask in the initial task matrix.

S302, according to an initial task matrix after movement and the task association table, generating a matrix of task to be processed through a strong connected relationship aggregation method.

S303, in a determination that the matrix of task to be processed is not a lower triangular matrix, generating a lower triangular matrix through a conversion method according to the matrix of task to be processed, and taking the lower triangular matrix as the target task matrix.

It should be noted that the task to be processed is an empty row subtask or an empty column subtask, and it is determined whether there is an empty row subtask or an empty column subtask in the initial task matrix.

It should be understood that if there is an empty row subtask or an empty column subtask in the initial task matrix, the empty row subtask or empty column subtask is marked and moved in the initial task matrix. According to the initial task matrix after moving the empty row subtask or the empty column subtask and the task association table, a strong connected determination matrix is obtained, and tasks with strong connected relationships are searched according to the strong connected determination matrix. Then the tasks with strong connected relationships are aggregated to obtain a matrix of task to be processed. Finally, it is determined whether the matrix of task to be processed is a lower triangular matrix. In a determination that the matrix of task to be processed is not the lower triangular matrix, then finally transform the strong connected determination matrix according to the conversion method to obtain a lower triangular matrix, and the lower triangular matrix is taken as the target task matrix.

In addition, in order to facilitate understanding, an example is provided as follows.

According to the task association relationship, the initial task matrix is marked with “1”. “task c depends on task b” is marked with “1” in row 3, column 2; “task f depends on task e” is marked with “1” in row 6, column 5; “task d depends on task a” is marked with “1” in row 4, column 1; “task c and task e are interdependent” is marked with “1” in row 3, column 5 and row 5, column 3; “task a and task f are interdependent” is marked with “1” in row 1, column 6 and row 6, column 1; a diagonal line from the upper left to the lower right is the relationship between the task and the task itself, and the “1” mark is also used. As shown in FIG. 3.

When the other elements of a certain row in the matrix are all 0 except for the diagonal elements, the task corresponding to this row does not require any information input and needs to be adjusted to the forefront. When the other elements of a certain column in the matrix are all 0 except for the diagonal elements, the task corresponding to this column does not output any information and needs to be adjusted to the end. As shown in FIG. 3, b is an empty row subtask, and d is an empty column subtask. Since the execution of c depends on b, the execution of b does not depend on c, and the execution of task b does not require any information input, therefore, it is necessary to move b to the front row, that is, the empty row subtask is arranged in the front row. The execution of d depends on a, but task d does not output any information. Therefore, it is necessary to move d to the last row, that is, the empty column subtask is arrange in the last row. Then the task execution sequence becomes b, a, c, e, f, d, and the initial task matrix after moving the empty row subtask or the empty column subtask is obtained. a, f, c, e are aggregated according to the strong connected relationship aggregation method, and then the strong connected determination matrix is obtained according to the above adjustment. According to the above description, let the initial task matrix after moving the empty row and empty column subtasks be P, and the strong connected determination matrix be Q, then:

$$P = \begin{matrix}b \\ a \\ c \\ e \\ f \\ d\end{matrix} [ \begin{matrix}1 & 0 & 0 & 0 & 0 & 0 \\ 0 & 1 & 0 & 0 & 1 & 0 \\ 1 & 0 & 1 & 1 & 0 & 0 \\ 0 & 0 & 1 & 1 & 0 & 0 \\ 0 & 1 & 0 & 1 & 1 & 0 \\ 0 & 1 & 0 & 0 & 0 & 1\end{matrix} ] , \\ Q = P ⊗ {P}^{T} = {( {p}_{ij} )}_{n \times n} = \begin{matrix}b \\ a \\ c \\ e \\ f \\ d\end{matrix} [ \begin{matrix}1 & 0 & 0 & 0 & 0 & 0 \\ 0 & 1 & 0 & 0 & 1 & 0 \\ 0 & 0 & 1 & 1 & 0 & 0 \\ 0 & 0 & 1 & 1 & 0 & 0 \\ 0 & 1 & 0 & 0 & 1 & 0 \\ 0 & 0 & 0 & 0 & 0 & 1\end{matrix} ]$$

From the matrix Q, it may be seen that the tasks with strong connected relationship are: in the strong connected matrix, it may be seen that the second row, fifth column and the fifth row, second column in the matrix are both marked with 1, that is, P25*P52=1, which is corresponded to task a and task f (Paf*Pfa=1 and (a is not equal to f)); and the third row, fourth column and fourth row, third column are both marked with 1, that is, P34*P43=1, which is corresponded to task c and task e (Pce*Pec=1 and (c is not equal to e)). Therefore, there is a strong connected relationship between task a and task f, task c and task e. Then tasks a, f, tasks c, e are aggregated to obtain a matrix of task to be processed. At this time, the task execution sequence is adjusted to b, a, f, c, e, d, and then it is determined whether the current matrix is a lower triangular matrix, if not, the matrix of task to be processed is adjusted to obtain a lower triangular matrix, which is shown in FIG. 4.

In this embodiment, in a determination that the initial task matrix includes an empty row subtask or an empty column subtask, taking the empty row subtask or the empty column subtask as the task to be processed, marking, moving and adjusting the empty row subtask or empty column subtask in the initial task matrix to obtain a matrix of task to be processed; in a determination that the matrix of task to be processed is not a lower triangular matrix, transforming the matrix of task to be processed to obtain a lower triangular matrix, and taking the lower triangular matrix as the target task matrix. So that by moving the empty row subtask or empty column subtask and determining the strong connected relationship, tasks may be given priority quickly and efficiently, tasks that have interdependent relationships may be merged, conflicts among tasks may be coordinated in advance, thereby avoiding uncertainty, and providing strong support for the planning and management of complex task projects.

In addition, an embodiment of this disclosure further provides a non-volatile storage medium with a task adjustment program stored thereon, and the task adjustment program, when executed by the processor, implements the operations of the task adjustment method as described above.

Referring to FIG. 6, FIG. 6 is a structural block diagram of a task adjustment device according to a first embodiment of this disclosure.

As shown in FIG. 6, the task adjustment device provided in an embodiment of this disclosure includes: an acquisition module 4001, a generation module 4002, a determination module 4003, a rule module 4004, a sequence module 4005, and a planning module 4006.

The acquisition module 4001 is configured for acquiring sequence IDs and associated conditions of target tasks, and establishing a task association table according to the sequence IDs and the associated conditions of the target tasks; the generation module 4002 is configured for generating an initial task matrix according to the sequence IDs of the target tasks and the task association table; the determination module 4003 is configured for determining whether the initial task matrix includes a task to be processed; the rule module 4004 is configured for in a determination that the initial task matrix includes the task to be processed, adjusting the initial task matrix through a preset rule according to a sequence ID corresponding to the task to be processed to generate a target task matrix; the sequence module 4005 is configured for obtaining a task sequence according to the target task matrix; and the planning module 4006 is configured for in a determination that the task sequence satisfies the task association table, generating an execution plan scheme according to the task sequence.

In order to facilitate the understanding that the acquisition module 4001 is configured for acquiring sequence IDs and associated conditions of target tasks, and establishing a task association table according to the sequence IDs and the associated conditions of the target tasks, a specific implementation manner is given as follows.

It should be noted that each task is marked with a sequence, so that each task has its own sequence ID. Then an associated condition corresponding to each task is acquired, and a task association table is established according to the sequence IDs and the associated conditions of the target tasks to facilitate finding logical relationship among tasks.

It should be understood that when establishing the task association table, it is necessary to first acquire the sequence IDs of the target tasks, and traverse the sequence IDs of the target tasks, then take a current target task corresponding to a traversed sequence ID as a current task to be associated. Then an associated condition corresponding to the current task to be associated is acquired to be matched with the target tasks, then a sequence ID corresponding to the current task to be associated and a sequence ID of a matched target task are associatively marked to generate an associated ID, and then a task association table is established according to the associated ID.

In addition, it should be noted that, in order to facilitate understanding, an example is provided as follows.

First, extract events based on an example, such as an installation plan of a roof steel structure and a roof curtain wall of a certain 150-meter tower, which has complicated logical relationships. In this case, due to the extremely narrow roof site of the 150-meter tower, the installation plan of the steel structure and the curtain wall of the roof was coordinated many times. After the roof curtain wall design is completed, the building's internal shading system may be designed and installed. In addition, the ice shovel truck needs to be in place under the tower before the steel may be transported to the top of the tower for construction; and the location of the ice shovel truck and the hoisting site condition survey on the work site affect each other. At present, the gate of the construction site is damaged and the ice shovel cannot enter the construction site.

It can be seen from the above example that there are a total of 6 target tasks, and each target task is marked with a sequence ID, which are a, b, c, d, e, f. Assuming that a is determination of curtain wall installation plan, b is that the construction site gate is damaged, and the ice shovel truck may enter after repair of the construction site gate, c is site condition survey of work site, d is determination of installation plan of internal shading system, e is the ice shovel truck in place, and f is determination of steel structure installation plan. Taking a as the current task to be associated, and then traverse the query from a to f. According to the task association condition of a, it may be known that both a and d or a and f may establish a task association connection, then a and d and a and f are marked. Then taking b as the current task to be associated, and then traverse the query from a to f. According to the task association condition of b, it may be known that b and c may establish a task association connection, then b and c are marked. Following this approach, subsequent tasks are traversed and task association connections are established. Finally, c and e may establish a task association connection, d has no task association connection so that d is a task to be processed, e and c and e and f may establish a task association connection, and f and a may establish a task association connection. Then the task association table may be established based on the above task associations.

It should be understood that the above is only an example, and does not constitute any limitation to the technical solution of this disclosure. In practical disclosures, those skilled in the art may make settings as needed, and there is no limitation here.

In addition, it is worth mentioning that the generation module 4002 is configured for generating an initial task matrix according to the sequence IDs of the target tasks and the task association table.

It should be noted that a number of target tasks is counted according to the sequence IDs of the tasks. An initial matrix of N rows and N columns is established according to the number of target tasks, and then an initial task matrix is generated according to the sequence IDs of the target tasks and the task association table.

In addition, it should be understood that, in order to facilitate understanding, an example is provided as follows.

It can be seen from S10 that the target tasks are marked with sequence IDs, which are a, b, c, d, e, f, and the task association relationships are a and d; a and f; b and c; c and e; d; e and c; e and f; and f and a. So an initial matrix of 6 rows and 6 columns needs to be established, and each row and each column are in a sequence of a, b, c, d, e, f. Then the task association relationships of the sequence IDs are inputted into the initial matrix by marking with “1” to obtain the initial task matrix. “task c depends on task b” is marked with “1” in row 3, column 2; “task f depends on task e” is marked with “1” in row 6, column 5; “task d depends on task a” is marked with “1” in row 4, column 1; “task c and task e are interdependent” is marked with “1” in row 3, column 5 and row 5, column 3; “task a and task f are interdependent” is marked with “1” in row 1, column 6 and row 6, column 1; a diagonal line from the upper left to the lower right is the relationship between the task and the task itself, and the “1” mark is also used. By observing the position of “1” in the initial matrix, the association among all tasks may be deduced backwards, and the initial task matrix may be obtained as shown in FIG. 3.

In addition, in order to facilitate understanding that the determination module 4003 is configured for determining whether the initial task matrix includes a task to be processed, and the rule module 4004 is configured for in a determination that the initial task matrix includes the task to be processed, adjusting the initial task matrix through a preset rule according to a sequence ID corresponding to the task to be processed to generate a target task matrix, the following description is given.

It should be noted that the task to be processed is an empty row subtask or an empty column subtask, and it is determined whether there is an empty row subtask or an empty column subtask in the initial task matrix.

It should be understood that if there is an empty row subtask or an empty column subtask in the initial task matrix, the empty row subtask or empty column subtask is marked and moved in the initial task matrix. According to the initial task matrix after moving the empty row subtask or the empty column subtask and the task association table, a matrix of task to be processed is obtained through the strong relationship aggregation method. Then, it is determined whether the matrix of task to be processed is a lower triangular matrix. In a determination that the matrix of task to be processed is not the lower triangular matrix, then finally transform the matrix of task to be processed according to the conversion method to obtain a lower triangular matrix, and the lower triangular matrix is taken as the target task matrix.

In addition, in order to facilitate understanding, an example is provided as follows.

According to the task association relationship, the initial task matrix is marked with “1”. “task c depends on task b” is marked with “1” in row 3, column 2; “task f depends on task e” is marked with “1” in row 6, column 5; “task d depends on task a” is marked with “1” in row 4, column 1; “task c and task e are interdependent” is marked with “1” in row 3, column 5 and row 5, column 3; “task a and task f are interdependent” is marked with “1” in row 1, column 6 and row 6, column 1; a diagonal line from the upper left to the lower right is the relationship between the task and the task itself, and the “1” mark is also used. As shown in FIG. 3.

When the other elements of a certain row in the matrix are all 0 except for the diagonal elements, the task corresponding to this row does not require any information input and needs to be adjusted to the forefront. When the other elements of a certain column in the matrix are all 0 except for the diagonal elements, the task corresponding to this column does not output any information and needs to be adjusted to the end. As shown in FIG. 3, b is an empty row subtask, and d is an empty column subtask. Since the execution of c depends on b, the execution of b does not depend on c, and the execution of task b does not require any information input, therefore, it is necessary to move b to the front row, that is, the empty row subtask is arranged in the front row. The execution of d depends on a, but task d does not output any information. Therefore, it is necessary to move d to the last row, that is, the empty column subtask is arrange in the last row. Then the task execution sequence becomes b, a, c, e, f, d, and the initial task matrix after moving the empty row subtask or the empty column subtask is obtained. a, f, c, e are aggregated according to the strong connected relationship aggregation method, and then the strong connected determination matrix is obtained according to the above adjustment. According to the above description, let the initial task matrix after moving the empty row and empty column subtasks be P, and the strong connected determination matrix be Q, then:

$$P = \begin{matrix}b \\ a \\ c \\ e \\ f \\ d\end{matrix} [ \begin{matrix}1 & 0 & 0 & 0 & 0 & 0 \\ 0 & 1 & 0 & 0 & 1 & 0 \\ 1 & 0 & 1 & 1 & 0 & 0 \\ 0 & 0 & 1 & 1 & 0 & 0 \\ 0 & 1 & 0 & 1 & 1 & 0 \\ 0 & 1 & 0 & 0 & 0 & 1\end{matrix} ] , \\ Q = P ⊗ {P}^{T} = {( {p}_{ij} )}_{n \times n} = \begin{matrix}b \\ a \\ c \\ e \\ f \\ d\end{matrix} [ \begin{matrix}1 & 0 & 0 & 0 & 0 & 0 \\ 0 & 1 & 0 & 0 & 1 & 0 \\ 0 & 0 & 1 & 1 & 0 & 0 \\ 0 & 0 & 1 & 1 & 0 & 0 \\ 0 & 1 & 0 & 0 & 1 & 0 \\ 0 & 0 & 0 & 0 & 0 & 1\end{matrix} ]$$

From the matrix Q, it may be seen that the tasks with strong connected relationship are: in the strong connected matrix, it may be seen that the second row, fifth column and the fifth row, second column in the matrix are both marked with 1, that is, P25*P52=1, which is corresponded to task a and task f (Paf*Pfa=1 and (a is not equal to f)); and the third row, fourth column and fourth row, third column are both marked with 1, that is, P34*P43=1, which is corresponded to task c and task e (Pce*Pec=1 and (c is not equal to e)). Therefore, there is a strong connected relationship between task a and task f, task c and task e. Then tasks a, f, tasks c, e are aggregated to obtain a matrix of task to be processed. At this time, the task execution sequence is adjusted to b, a, f, c, e, d, and then it is determined whether the current matrix is a lower triangular matrix, if not, the matrix of task to be processed is adjusted to obtain a lower triangular matrix, which is shown in FIG. 4.

It should be understood that the above is only an example, and does not constitute any limitation to the technical solution of this disclosure. In practical disclosures, those skilled in the art may make settings as needed, and there is no limitation here.

In addition, it is worth mentioning that the sequence module 4005 is configured for obtaining a task sequence according to the target task matrix, and the planning module 4006 is configured for in a determination that the task sequence satisfies the task association table, generating an execution plan scheme according to the task sequence, which are specifically described as follows.

It should be noted that, according to the target task matrix, the sequence ID corresponding to each task is extracted from top to bottom and from front to back according to each row and column in the matrix. According to the above example, it may be seen that the task sequence obtained by the adjusted lower triangular matrix is b, c, e, a, f, d.

In addition, it should be noted that the sequence is verified according to the task association table, and if the connection is correct, an optimal task execution plan is generated according to the task sequence. If the task sequence does not satisfy the task association table, the initial matrix needs to be re-established until the optimal execution plan for task association is obtained.

It should be understood that the above is only an example, and does not constitute any limitation to the technical solution of this disclosure. In specific disclosures, those skilled in the art may make settings as needed, and there is no limitation here.

In this embodiment, acquiring sequence IDs and associated conditions of target tasks, and establishing a task association table according to the sequence IDs and the associated tasks of the target tasks; generating an initial task matrix according to the sequence IDs of the target tasks and the task association table; in a determination that the initial matrix includes an empty row subtask or an empty column subtask, taking the empty row subtask or empty column subtask as the task to be processed, marking, moving and adjusting the empty row subtask or empty column subtask, and then generating a matrix of task to be processed; in a determination that the matrix of task to be processed is not a lower triangular matrix, adjusting the matrix of task to be processed to generate a target task matrix; obtaining a task sequence according to the target task matrix; and in a determination that the task sequence satisfies the task association table, generating the task sequence into an execution plan scheme. In this way, the optimal task sorting scheme may be obtained quickly and efficiently according to the association relationship among tasks, thereby improving the efficiency of user processing tasks and reducing the time waste and cost of construction projects.

It should be noted that the work flow described above is only illustrative, and does not limit the scope of protection of this disclosure. In practical disclosures, those skilled in the art may select some or all of them according to actual needs to realize the object of this embodiment, without limitation here.

In addition, for technical details that are not described in detail in this embodiment, please refer to the task adjustment method provided by any embodiment of this disclosure, which will not be repeated here.

In addition, it should be noted that in this article, the terms “comprise”, “include” or any other variant thereof are intended to cover non-exclusive inclusion, so that a process, method, article or system that includes a series of elements includes not only those elements, but also other elements that are not explicitly listed, or include elements inherent to this process, method, article, or system. If there are no more restrictions, the element defined by the sentence “including a . . . ” does not exclude the existence of other identical elements in the process, method, article or system that includes the element.

The sequence numbers of the foregoing embodiments of this disclosure are only for description, and do not represent the superiority of the embodiments.

Through the description of the above embodiments, those skilled in the art can clearly understand that the methods in the above embodiments can be implemented by means of software plus a necessary general hardware platform, and of course, can also be implemented by hardware, but in many cases the former is better. Based on this understanding, the technical solution of this disclosure can be embodied in the form of a software product in essence or part that contributes to the existing technology, and the computer software product is stored in a storage medium (such as Read Only Memory (ROM)/Random Access Memory (RAM), magnetic disk, optical disk) including several instructions to enable a terminal device (which may be a mobile phone, computer, server, or network device, etc.) to execute the methods described in the embodiments of this disclosure.

The above are only preferred embodiments of this disclosure and do not limit the patent scope of this disclosure. Any equivalent structure or equivalent process transformation made by the description and drawings of this disclosure, or directly or indirectly used in other related technical fields are similarly included in the patent protection scope of this disclosure.

What is claimed is:

1. A task adjustment method, comprising:
acquiring sequence IDs and associated conditions of target tasks, and establishing a task association table according to the sequence IDs and the associated conditions of the target tasks;
generating an initial task matrix according to the sequence IDs of the target tasks and the task association table;
in a determination that the initial task matrix comprises a task to be processed, adjusting the initial task matrix through a preset rule according to a sequence ID corresponding to the task to be processed to generate a target task matrix;
obtaining a task sequence according to the target task matrix; and
in a determination that the task sequence satisfies the task association table, generating an execution plan scheme according to the task sequence.

2. The method of claim 1, wherein acquiring sequence IDs and associated conditions of target tasks, and establishing a task association table according to the sequence IDs and the associated conditions of the target tasks comprises:
acquiring the sequence IDs of the target tasks, and traversing the sequence IDs of the target tasks;
taking a current target task corresponding to a traversed sequence ID as a current task to be associated;
acquiring an associated condition corresponding to the current task to be associated;
matching the associated condition corresponding to the current task to be associated with the target tasks;
associatively marking a sequence ID corresponding to the current task to be associated and a sequence ID of a matched target task to generate an associated ID; and
establishing the task association table according to the associated ID.

3. The method of claim 1, wherein generating an initial task matrix according to the sequence IDs of the target tasks and the task association table comprises:
counting a number of the target tasks according to the sequence IDs of the target tasks;
establishing an initial matrix with N rows and N columns according to the number of the target tasks, where N is the number of the target tasks; and
inputting the sequence IDs of the target tasks and the task association table into the initial matrix with N rows and N columns to obtain the initial task matrix.

4. The method of claim 1, wherein the task to be processed is an empty row subtask or an empty column subtask; and
wherein in a determination that the initial task matrix comprises a task to be processed, adjusting the initial task matrix through a preset rule according to a sequence ID corresponding to the task to be processed to generate a target task matrix comprises:
in a determination that the initial task matrix comprises the empty row subtask or the empty column subtask, adjusting the initial task matrix through the preset rule according to the sequence ID corresponding to the task to be processed to generate the target task matrix.

5. The method of claim 4, wherein in a determination that the initial task matrix comprises a task to be processed, adjusting the initial task matrix through a preset rule according to a sequence ID corresponding to the task to be processed to generate a target task matrix comprises:
in a determination that the initial task matrix comprises the empty row subtask or the empty column subtask, marking and moving the empty row subtask or the empty column subtask in the initial task matrix;
according to an initial task matrix after moving the empty row subtask or the empty column subtask and the task association table, generating a matrix of task to be processed through a strong connected relationship aggregation method;
in a determination that the matrix of task to be processed is not a lower triangular matrix, generating a lower triangular matrix through a conversion method according to the matrix of task to be processed; and
taking the lower triangular matrix as the target task matrix.

6. The method of claim 5, wherein obtaining a task sequence according to the target task matrix comprises:
extracting the sequence IDs corresponding to the target tasks and the sequence ID corresponding to the task to be processed according to the target task matrix; and
arranging the sequence IDs corresponding to the target tasks and the sequence ID corresponding to the task to be processed to obtain the task sequence.

7. The method of claim 1, wherein after obtaining a task sequence according to the target task matrix, the method further comprises:
in a determination that the task sequence does not satisfy the task association table, performing the operation of generating an initial task matrix according to the sequence IDs of the target tasks and the task association table.

8. An electronic equipment, comprising: a memory, a processor, and a task adjustment program stored on the memory and executable on the processor, and the task adjustment program is configured to implement the following operations:
acquiring sequence IDs and associated conditions of target tasks, and establishing a task association table according to the sequence IDs and the associated conditions of the target tasks;
generating an initial task matrix according to the sequence IDs of the target tasks and the task association table;
in a determination that the initial task matrix comprises a task to be processed, adjusting the initial task matrix through a preset rule according to a sequence ID corresponding to the task to be processed to generate a target task matrix;
obtaining a task sequence according to the target task matrix; and
in a determination that the task sequence satisfies the task association table, generating an execution plan scheme according to the task sequence.

9. The electronic equipment of claim 8, wherein the task adjustment program is configured to implement the following operations:
acquiring the sequence IDs of the target tasks, and traversing the sequence IDs of the target tasks;
taking a current target task corresponding to a traversed sequence ID as a current task to be associated;
acquiring an associated condition corresponding to the current task to be associated;
matching the associated condition corresponding to the current task to be associated with the target tasks;
associatively marking a sequence ID corresponding to the current task to be associated and a sequence ID of a matched target task to generate an associated ID; and
establishing the task association table according to the associated ID.

10. The electronic equipment of claim 8, wherein the task adjustment program is configured to implement the following operations:
counting a number of the target tasks according to the sequence IDs of the target tasks;
establishing an initial matrix with N rows and N columns according to the number of the target tasks, where N is the number of the target tasks; and
inputting the sequence IDs of the target tasks and the task association table into the initial matrix with N rows and N columns to obtain the initial task matrix.

11. The electronic equipment of claim 8, wherein the task to be processed is an empty row subtask or an empty column subtask, and the task adjustment program is configured to implement the following operations:
wherein in a determination that the initial task matrix comprises a task to be processed, adjusting the initial task matrix through a preset rule according to a sequence ID corresponding to the task to be processed to generate a target task matrix comprises:
in a determination that the initial task matrix comprises the empty row subtask or the empty column subtask, adjusting the initial task matrix through the preset rule according to the sequence ID corresponding to the task to be processed to generate the target task matrix.

12. The electronic equipment of claim 11, wherein the task adjustment program is configured to implement the following operations:
in a determination that the initial task matrix comprises the empty row subtask or the empty column subtask, marking and moving the empty row subtask or the empty column subtask in the initial task matrix;
according to an initial task matrix after moving the empty row subtask or the empty column subtask and the task association table, generating a matrix of task to be processed through a strong connected relationship aggregation method;
in a determination that the matrix of task to be processed is not a lower triangular matrix, generating a lower triangular matrix through a conversion method according to the matrix of task to be processed; and
taking the lower triangular matrix as the target task matrix.

13. The electronic equipment of claim 12, wherein the task adjustment program is configured to implement the following operations:
extracting the sequence IDs corresponding to the target tasks and the sequence ID corresponding to the task to be processed according to the target task matrix; and
arranging the sequence IDs corresponding to the target tasks and the sequence ID corresponding to the task to be processed to obtain the task sequence.

14. A non-volatile storage medium, wherein a task adjustment program is stored on the storage medium, and the task adjustment program, when executed by a processor, implements the following operations:
acquiring sequence IDs and associated conditions of target tasks, and establishing a task association table according to the sequence IDs and the associated conditions of the target tasks;
generating an initial task matrix according to the sequence IDs of the target tasks and the task association table;
in a determination that the initial task matrix comprises a task to be processed, adjusting the initial task matrix through a preset rule according to a sequence ID corresponding to the task to be processed to generate a target task matrix;
obtaining a task sequence according to the target task matrix; and
in a determination that the task sequence satisfies the task association table, generating an execution plan scheme according to the task sequence.

15. The non-volatile storage medium of claim 14, wherein the task adjustment program, when executed by a processor, implements the following operations:
acquiring the sequence IDs of the target tasks, and traversing the sequence IDs of the target tasks;
taking a current target task corresponding to a traversed sequence ID as a current task to be associated;
acquiring an associated condition corresponding to the current task to be associated;
matching the associated condition corresponding to the current task to be associated with the target tasks;
associatively marking a sequence ID corresponding to the current task to be associated and a sequence ID of a matched target task to generate an associated ID; and
establishing the task association table according to the associated ID.

16. The non-volatile storage medium of claim 14, wherein the task adjustment program, when executed by a processor, implements the following operations:
counting a number of the target tasks according to the sequence IDs of the target tasks;
establishing an initial matrix with N rows and N columns according to the number of the target tasks, where N is the number of the target tasks; and
inputting the sequence IDs of the target tasks and the task association table into the initial matrix with N rows and N columns to obtain the initial task matrix.

17. The non-volatile storage medium of claim 14, wherein the task to be processed is an empty row subtask or an empty column subtask, and the task adjustment program, when executed by a processor, implements the following operations:
wherein in a determination that the initial task matrix comprises a task to be processed, adjusting the initial task matrix through a preset rule according to a sequence ID corresponding to the task to be processed to generate a target task matrix comprises:
in a determination that the initial task matrix comprises the empty row subtask or the empty column subtask, adjusting the initial task matrix through the preset rule according to the sequence ID corresponding to the task to be processed to generate the target task matrix.

18. The non-volatile storage medium of claim 17, wherein the task adjustment program, when executed by a processor, implements the following operations:
in a determination that the initial task matrix comprises the empty row subtask or the empty column subtask, marking and moving the empty row subtask or the empty column subtask in the initial task matrix;
according to an initial task matrix after moving the empty row subtask or the empty column subtask and the task association table, generating a matrix of task to be processed through a strong connected relationship aggregation method;
in a determination that the matrix of task to be processed is not a lower triangular matrix, generating a lower triangular matrix through a conversion method according to the matrix of task to be processed; and
taking the lower triangular matrix as the target task matrix.

19. The non-volatile storage medium of claim 18, wherein the task adjustment program, when executed by a processor, implements the following operations:
extracting the sequence IDs corresponding to the target tasks and the sequence ID corresponding to the task to be processed according to the target task matrix; and
arranging the sequence IDs corresponding to the target tasks and the sequence ID corresponding to the task to be processed to obtain the task sequence.
